(19) United States
(12) Patent Application Publication
(10) Pub. No.: US 2006/0131894 A1
(43) Pub. Date: Jun. 22, 2006

(54) Motor vehicle door lock

(75) Inventor: Ludger Graute, Essen (DE)

Correspondence Address: MATTHIAS SCHOLL, 14781 MEMORIAL DRIVE, SUITE 1319, HOUSTON, TX, 77079, US

(73) Assignee: Kiekert Aktiengesellschaftkettwiger STR.

(21) Appl. No.: 10/555,378

(22) PCT Filed: Apr. 30, 2004
(86) PCT No.: PCT/DE04/00918

§ 371 Date: Nov. 2, 2005

(30) Foreign Application Priority Data
May 8, 2003 (DE) 103 20 459.8

(51) Int. Cl. E05C 3/06

(52) U.S. Cl. 292/216

(57) ABSTRACT

The invention refers to a vehicle door latch with a catch and pawl, in which the catch contains a cushioning stop and said cushioning stop being designed as a spring stop for the reset spring of the catch on its non-cushioning side.

### CROSS-REFERENCE TO RELATED APPLICATIONS

This is a National Stage Application of International Patent Application No. PCT/DE 2004/000918, with an international filing date of Apr. 30, 2004, which is based on German Patent Application No. 103 20 459.8, filed May 8, 2003. The contents of both of these specifications are incorporated herein by reference.

### BACKGROUND OF THE INVENTION

1. Field of the Invention

The invention refers to vehicle door latch with at least one locking mechanism containing a catch, acted upon by a reset spring and a pawl and an inlet opening as well as a locking pin cooperating with the catch (on a respective vehicle door).

2. Description of Related Art

In the reference system of the vehicle door latch, the locking pin moves into the inlet opening. Generally, the locking pin is located on the vehicle body whilst, in contrast, the vehicle door latch and logically the inlet opening are moved.

Such a vehicle door latch is known in which the inlet opening contains a cushioning element, which ensures that the locking pin moving into the inlet opening and then held in its primary position by the catch, is fixed in this position with less noise (see EP 0 336 034 A2).—Irrespective of this, a reset spring acts upon the catch to turn the catch from its closed position back into its open position after disengagement of the pawl assigned to it, when the vehicle door is being opened or is open. For this reset spring, a spring stop is molded on the catch. This is costly from a material and production point of view.—The invention aims to solve this problem.

### BRIEF DESCRIPTION OF THE DRAWINGS

Below, the invention is explained in detail with reference to a drawing representing only one embodiment of the invention, in which:

FIG. 1 shows a vehicle door latch of the invention with top view onto a back plate with a locking mechanism, without a reset spring and with a cushioning stop for the catch, and

FIG. 2 an enlarged excerpt from the object of FIG. 1 including reset spring and cushioning stop for the catch.

### BRIEF SUMMARY OF THE INVENTION

The invention described herein provides a vehicle door latch with at least one locking mechanism (2, 3) containing a catch (2) being acted upon by a reset spring (1) and a pawl (3) and with an inlet opening (5) as well as a locking pin (6), cooperating wit the catch (2), characterized in that the catch (2) contains a cushioning stop (7) and that the cushioning stop (7) is designed as a spring stop (7a) for the reset spring (1) on its non-cushioning side.

In certain embodiments of the invention described herein, the catch (2) is encased with soundproofing material, such as thermoplastic plastic such as polyurethane and that the cushioning stop (7) and spring stop (7a) are part of the casing (9).

In certain embodiments of the invention described herein, the cushioning stop (7) is designed as a stop rib arranged in the area around the catch.

In certain embodiments of the invention described herein, the stop rib (7) contains a pocket-like recess (10).

In certain embodiments of the invention described herein, the stop rib (7) contains a stop face (7b) at one end and a spring connection (11), such as a connection projection, at its other end.

### DETAILED DESCRIPTION OF THE INVENTION

The invention has the task of providing a vehicle door latch of the type described above, in which the catch operates quietly and offers a simpler construction.

The invention solves the task in a vehicle door latch of the described type by the catch containing a cushioning stop and this cushioning stop on its non-cushioning side also being designed as a spring stop for the reset spring.—The invention is based on the knowledge that in case of a vehicle door latch, a considerable noise reduction as part of, in particular, the opening process, can be achieved if not only a cushioning element is provided for the locking pin of the assigned vehicle door, but in addition also a cushioning stop for the catch. The cushioning stop for the catch can, at the same time, cooperate with the cushioning element for the locking pin. Such a cushioning stop can, at the same time, also be designed as a spring stop for the reset spring, so that a separate spring stop, molded on the catch, is no longer required. In this way a, from a production and technical point of view, simpler construction is achieved, saving on material and mass. According to a preferred embodiment of the invention, the catch is encased in a soundproofing material, such as plastic or polyurethane or similar, with the cushioning and spring stop forming a part of this casing. Such a plastic casing with cushioning and spring stop is relatively easy to produce and relatively light, so that in this way the above mass reduction can be achieved, which is of considerable importance for moving parts.

Other measures of the invention are listed below. According to the invention, the cushioning stop is, for instance, designed as a stop rib arranged around the edge of the catch, following the perimeter of the catch over a specified partial section. For this purpose, the stop rib contains a pocket-like recess and consequently also operates like a buffer, so that an increased cushioning effect is achieved. The stop rib also contains an uncovered stop face at one end and a spring connection for the reset spring at the other end, such as a connection projection for the legs of a reset spring, designed as a leg spring.

The figures show a vehicle door latch with at least one locking mechanism, containing a catch 2 acted upon by a reset spring 1 and a pawl 3 cooperating with catch 2 in a back plate 4, and a locking pin 6 moving into an inlet opening 5 and cooperating with the catch 2 in a respective vehicle door that is only indicated. The reset spring 1 acts upon the catch 2 in the opening sense and consequently in clockwise direction, indicated by an arrow. The pawl 3 can be activated mechanically, by a lever mechanism—not shown—or also by means of a motor, in particular an electric motor.

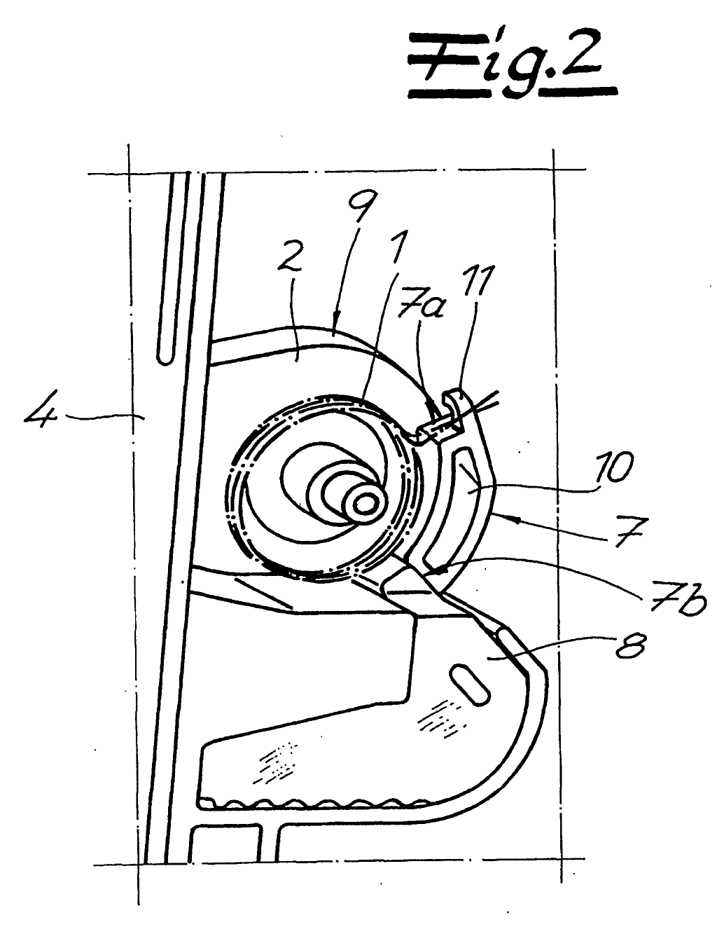

The catch 2 contains a cushioning stop 7, moving in the opened position (clockwise in FIG. 2) against a buffer-like cushioning element 8. This cushioning element 8 is located in the back plate 4. The cushioning stop 7 on the catch 2 is designed as a spring stop 7a for the reset spring 1 on its non-cushioning side. The catch 2 and, where applicable, also the pawl 3, to some extent, are encased with a soundproofing material such as plastic or polyurethane, with the cushioning stop 7 and the spring stop 7a being part of the casing 9. The cushioning stop 7 is designed as a stop rib, arranged around the edge of the catch and following the periphery of the catch 2 over a partial section. This stop rib 7 contains a pocket-like recess 10 and is therefore also characterized by its own buffering effect. The stop rib 7 contains a simple stop face 7b at its cushioning end and a spring connection 11, such as a connection projection for the reset spring 1, designed for instance as a leg spring, at its other end. All in all, a locking mechanism low in friction and noise is provided, which is characterized by its simple and its well functioning construction.

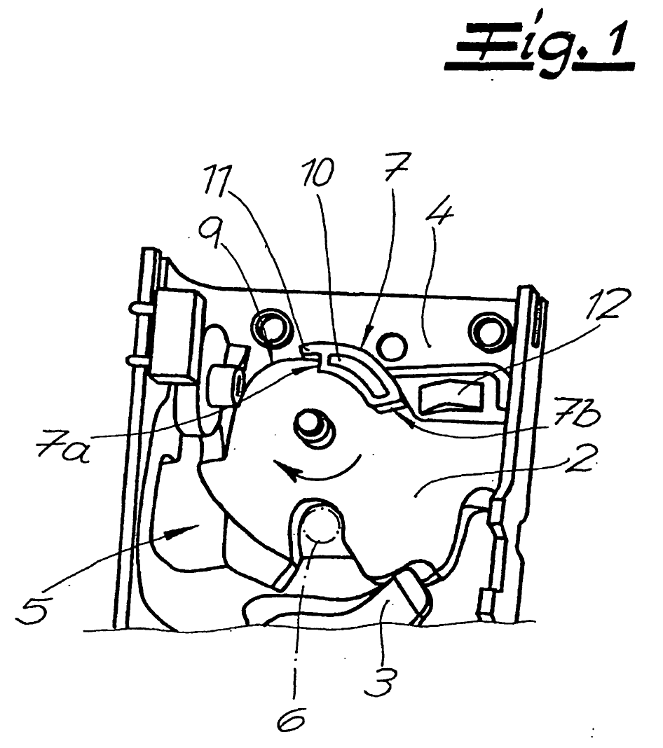

FIG. 1 also shows a stop 12 in the back plate or latch housing, which limits or restricts an overtravel of catch 2. The cushioning stop 7 serves, on the other hand, for stopping or limiting the opening movement of the catch 2. The cushioning stop 7 can also be equipped with one or several reinforcement ribs.

1-5. (canceled)

6. A vehicle door latch with at least one locking mechanism (2, 3) comprising:
a latch housing (4), having an inlet opening (5) for receiving a locking pin (6);
a catch (2) having a casing (9) and a periphery;
a reset spring (1) for resetting said catch (2); and
a pawl (3);
wherein
said catch (2) comprises a cushioning stop (7), said cushioning stop (7) being disposed around a partial section of said periphery of catch (2), said cushioning stop (7) having a cushioning side (7b) and a non-cushioning side (7a), said cushioning stop (7) limiting an opening movement of said catch (2); and said non-cushioning side (7a) having a spring connection (11) for said reset spring (1), said reset spring (1) being connected to said spring connection (11).

7. The vehicle door latch of claim 6, wherein said catch (2) is encased with a soundproofing material.

8. The vehicle door latch of claim 6, wherein said pawl (3) is encased with a soundproofing material.

9. The vehicle door latch of claim 7, wherein said soundproofing material is made of plastic.

10. The vehicle door latch of claim 8, wherein said soundproofing material is made of plastic.

11. The vehicle door latch of claim 9, wherein said soundproofing material is made of polyurethane.

12. The vehicle door latch of claim 10, wherein said soundproofing material is made of polyurethane.

13. The vehicle door latch of claim 7, wherein said casing (9) comprises said cushioning stop (7).

14. The vehicle door latch of claim 7, wherein said cushioning stop (7) comprises further a pocket-like recess (10).

15. The vehicle door latch of claim 7 comprising further a cushioning element (8), said cushioning element (8) disposed on the latch housing (4), wherein said cushioning stop (7) is movable against said cushioning element (8).

16. The vehicle door latch of claim 7 comprising further a second stop (12), said second stop (12) being disposed on the latch housing (4), and said second stop (12) limiting an overtravel of said catch (2).

17. The vehicle door latch of claim 7, wherein said cushioning stop (7) limits an opening movement of said catch (2).

18. The vehicle door latch of claim 7, wherein said cushioning stop (7) comprises one or more reinforcement ribs.

19. A vehicle door latch with at least one locking mechanism (2, 3) comprising:
a latch housing (4), having an inlet opening (5) for receiving a locking pin (6);
a catch (2) having a casing (9) made of a soundproofing material;
a reset spring (1) for said catch (2); and
a pawl (3);
wherein
said casing (9) comprises a cushioning stop (7), said cushioning stop (7) being disposed around a partial section of said periphery of catch (2), said cushioning stop (7) having a cushioning side (7b) and a non-cushioning side (7a), said cushioning stop (7) limiting an opening movement of said catch (2); and said non-cushioning side (7a) having a spring connection (11) for said reset spring (1), said reset spring (1) being connected to said spring connection (11).

20. The vehicle door latch of claim 19, wherein said soundproofing material is made of plastic.

21. The vehicle door latch of claim 20, wherein said soundproofing material is made of polyurethane.

22. The vehicle door latch of claim 19, wherein said cushioning stop (7) comprises further a pocket-like recess (10).

23. The vehicle door latch of claim 19 comprising further a cushioning element (8), said cushioning element (8) disposed on the latch housing (4), wherein said cushioning stop (7) is movable against said cushioning element (8).

24. The vehicle door latch of claim 19 comprising further a second stop (12), said second stop (12) being disposed on the latch housing (4), and said second stop (12) limiting an overtravel of said catch (2).

25. The vehicle door latch of claim 19, wherein said cushioning stop (7) limits an opening movement of said catch (2).

26. The vehicle door latch of claim 19, wherein said cushioning stop (7) comprises one or more reinforcement ribs.

27. A vehicle door latch with at least one locking mechanism (2, 3) comprising:
a latch housing (4), having an inlet opening (5) for receiving a locking pin (6), and having a cushioning element (8);
a catch (2);
a reset spring (1) for said catch (2); and
a pawl (3);
wherein
said catch (2) comprises a casing (9), a periphery, and cushioning stop (7), said cushioning stop (7) being disposed around a partial section of said periphery, said cushioning stop (7) having a cushioning side (7b) and a non-cushioning side (7a), said cushioning stop (7) comprising pocket-like recess (10); said cushioning stop (7) limiting an opening movement of said catch (2); said non-cushioning side (7a) having a spring connection (11) for said reset spring (1), said reset spring (1) being connected to said spring connection (11);
said casing (9) is made of a soundproofing material selected from the group consisting of plastic and polyurethane; and
said cushioning stop (7) is movable against said cushioning element (8).

28. The vehicle door latch of claim 27 comprising further a second stop (12), said second stop (12) being disposed on the latch housing (4), and said second stop (12) limiting an overtravel of said catch (2).
